(19) United States
(12) Patent Application Publication
(10) Pub. No.: US 2026/0347220 A1
(43) Pub. Date: Nov. 5, 2026

(54) ULTRAVIOLET RADIATION BASED MULTI-STACK FLUID DISINFECTION SYSTEM

(71) Applicants: Paul K. Westerhoff, Scottsdale, AZ (US); Shahnawaz Sinha, Chandler, AZ (US)

(72) Inventors: Paul K. Westerhoff, Scottsdale, AZ (US); Shahnawaz Sinha, Chandler, AZ (US)

(21) Appl. No.: 19/665,925

(22) Filed: May 1, 2026

Related U.S. Application Data
(60) Provisional application No. 63/798,172, filed on May 1, 2025.

(51) Int. Cl. C02F 1/32; C02F 103/00

(52) U.S. Cl. CPC C02F 1/325; C02F 2103/003; C02F 2201/009; C02F 2201/3227

(57) ABSTRACT

A reactor includes an input plate defining a spiral channel, wherein the spiral channel defines an inlet through hole and an outlet through hole and is configured to accept a first elongated member. The first elongated member is configured to provide UV radiation along the length of the spiral channel. The reactor includes an output plate defining a spiral channel, wherein the spiral channel defines an inlet through hole and an outlet through hole and is configured to accept a second elongated member. The second elongated member is configured to provide UV radiation along the length of the spiral channel. The input plate is configured to couple to the output plate such that fluid provided to the input plate flows through the spiral channels of the input plate and the output plate and exits the reactor through the outlet through hole of the output plate.

### CROSS-REFERENCE TO RELATED APPLICATION

This application claims the benefit of U.S. Patent Application No. 63/798,172 filed on May 1, 2025, which is incorporated by reference herein in its entirety.

### TECHNICAL FIELD

This invention relates to light-driven fluid disinfection systems.

### BACKGROUND

Pathogenic bacteria, viruses, and protozoa are examples of biological contaminants in drinking water. Fluid treatment systems use various methods to remove contaminants from fluid. In some fluid treatment systems, chlorine is used as a chemical-based disinfectant. In certain fluid treatment systems, mercury-based ultraviolet-C (UVC) (254 nm) lamps contained within glass cylinders are used. In these systems, the UVC lamp is typically installed inside a quartz sleeve in a cylindrical stainless steel ultraviolet (UV)-reactor.

### SUMMARY

This disclosure describes a stackable fluid disinfection system. The system includes two or more reactor plates and an elongated member configured to emit ultraviolet (UV) radiation. A housing design (e.g., spiral) in each reactor plate is configured to promote plug-flow motion. The number of plates used for the reactor system can vary based on the volume of fluid or contact time estimated for the disinfection. The elongated members are coated with a water-resistant material such that the fluid can come into contact with the elongated members during the reaction without the use of an additional covering (e.g., quartz sleeve). A concentration of contaminants (e.g., E. coli) in the fluid decreases after undergoing UV radiation treatment in the disinfection system. The stackable fluid disinfection system can be configured to allow fluid flow in either a downward or upward direction (e.g., with or against gravity).

In a first general aspect, a reactor includes an input plate defining a spiral channel on a first surface, wherein the spiral channel defines an inlet through hole and an outlet through hole and is configured to accept a first elongated member along a length of the spiral channel, and the first elongated member is configured to provide UV radiation from a first UV radiation source along the length of the spiral channel; and an output plate defining a spiral channel on a first surface, wherein the spiral channel defines an inlet through hole and an outlet through hole and is configured to accept a second elongated member along a length of the spiral channel, and the second elongated member is configured to provide UV radiation from a second UV radiation source along the length of the spiral channel. The input plate is configured to couple to the output plate such that fluid provided to the inlet through hole of the input plate flows through the spiral channel of the input plate, the outlet through hole of the input plate, the inlet through hole of the output plate, and the spiral channel of the output plate, and exits the reactor through the outlet through hole of the output plate.

Implementations of the first general aspect can include one or more of the following features.

In some cases, the input plate includes plastic, clay, polymer, or any combination thereof. The output plate can include plastic, clay, polymer, or any combination thereof. In some implementations, the first and second elongated members are flexible. Each elongated member can include a UV-LED strip, a side-emitting optical fiber, or any combination thereof.

A diameter of the side-emitting optical fiber can be in a range of 200 μm to 500 μm. The side-emitting optical fiber can include a fluoropolymer coating. In some cases, a thickness of the fluoropolymer coating is in a range of 10 μm to 20 μm. Each elongated member can include a water-resistant coating. In some implementations, the water-resistant coating includes a fluoropolymer.

The first general aspect can further include a power source operatively coupled to the first elongated member and the second elongated member, and configured to provide power to the first UV radiation source and the second UV radiation source. The power source can include a battery, a photovoltaic panel, or any combination thereof.

In some cases, the first general aspect further includes a gasket configured to form a seal between the input plate and the output plate. The first general aspect can further include a pump configured to provide the fluid to the inlet through hole of the input plate.

In some cases, the first general aspect further includes one or more additional plates, each defining a spiral channel on a first surface, wherein each spiral channel defines an inlet through hole and an outlet through hole and is configured to accept an additional elongated member along a length of the spiral channel, and the additional elongated member is configured to provide UV radiation from an additional UV radiation source along the length of the additional spiral channel, wherein the one or more additional plates are positioned between the input plate and the output plate, and wherein fluid provided to the inlet through hole of the input plate flows through the one or more additional plates and the output plate and exits the reactor through the outlet through hole of the output plate.

In a second general aspect, treating a fluid includes providing the fluid to the inlet through hole of the input plate of the first general aspect, and flowing the fluid through the spiral channel of the input plate and the spiral channel of the output plate, thereby irradiating the fluid in the spiral channel of the input plate and the spiral channel of the output plate with the UV radiation to yield a treated fluid.

Implementations of the second general aspect can include one or more of the following features.

In some cases, the fluid is in direct contact with the first and second elongated members. The second general aspect can further include pumping the fluid through the inlet through hole of the input plate. In some implementations, the fluid includes water. In certain cases, a contaminant level in the fluid exceeds a contaminant level in the treated fluid.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B are schematic diagrams of an example reactor. FIG. 1C is a schematic diagram illustrating a top view of an example reactor plate. FIG. 1D is a schematic diagram illustrating a bottom view of an example reactor plate. FIG. 1E is a schematic diagram of an example reactor with an elongated member.

FIG. 2 is a flow chart showing operations in an example process of treating a fluid.

### DETAILED DESCRIPTION

This disclosure describes the use of elongated members (e.g., water resistant ultraviolet-C (UVC)-light emitting diode (LED) strips, side-emitting optical fibers) in a stackable fluid disinfection system. The reactor system provides a plug-flow geometry (e.g., serpentine geometry with baffle walls) that promotes uniform treatment time of the fluid. This design allows fluid (e.g., water) to enter spiral channels close to the elongated members for adequate disinfection. The reactor system can be powered by batteries, photovoltaic panels, solar panels, or a combination thereof.

The plug-flow reactor geometry is used over other reactor design types (e.g., cylindrical reactor) at least in part because the plug-flow geometry can allow a laminar flow of the fluid. Reactors with a plug-flow geometry move the fluid primarily in one direction, reducing or minimizing mixing between fluids that enter the reactor at different times. At least in part by limiting mixing in the direction of flow, the plug-flow geometry allows for a similar treatment time for fluids processed within the reactor.

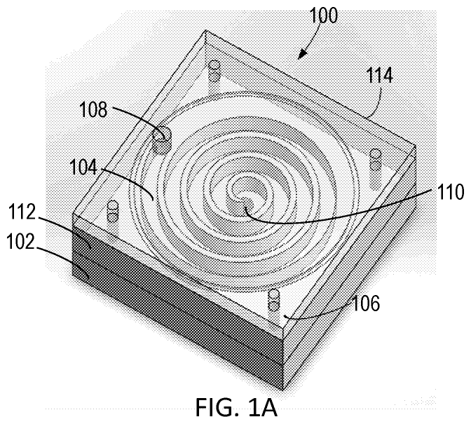

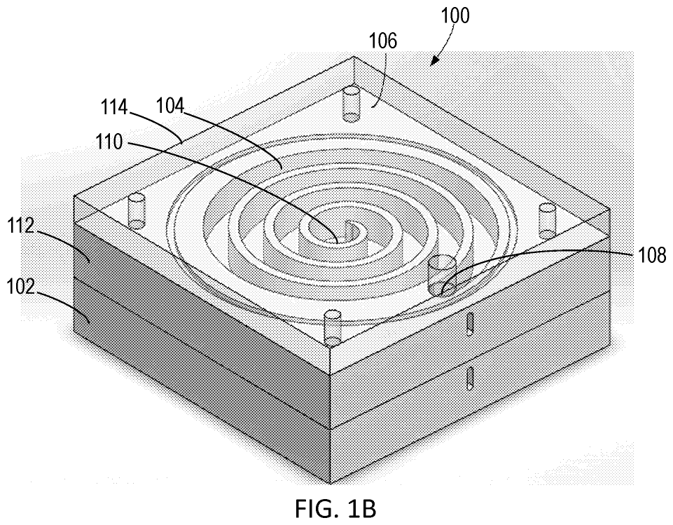

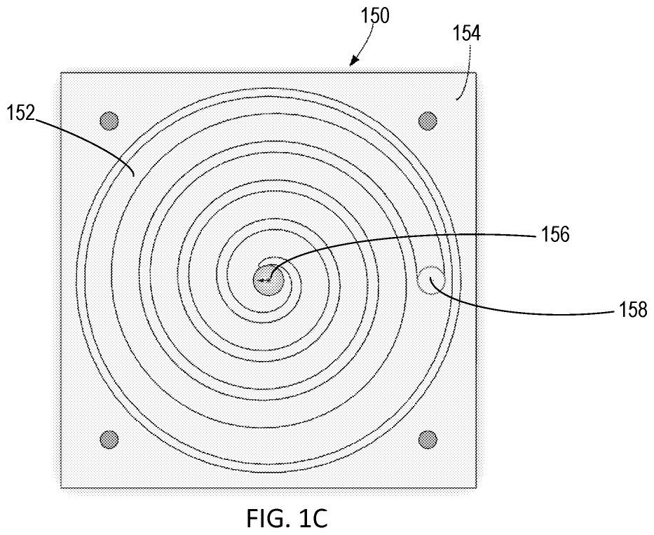

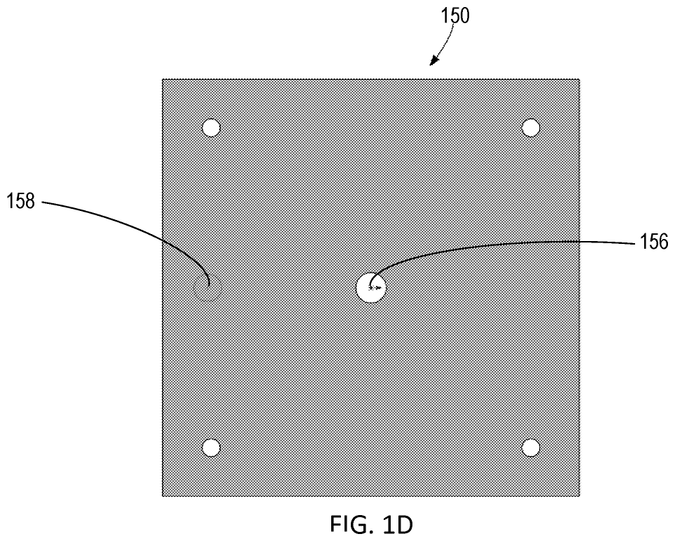

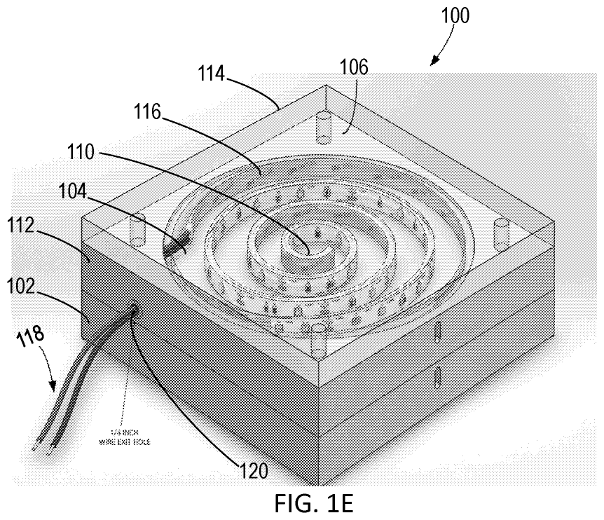

FIGS. 1A and 1B illustrate an example of a stackable reactor 100 with a fluid flow in an upward direction (e.g., opposite the force of gravity). The reactor 100 includes two or more reactor plates (e.g., input plate 102, output plate 112). The two or more reactor plates are similarly structured. Each reactor plate 150 of the two or more reactor plates includes a spiral channel 152 on a first surface 154, a first through hole 156, and a second through hole 158, as shown in FIGS. 1C and 1D. The first through hole 156 and the second through hole 158 can function as an inlet through hole or an outlet through hole depending on the position of the reactor plate within the reactor and the direction of fluid flow.

Referring to FIGS. 1A, 1B, and 1E, the output plate 112 defines a spiral channel 104 on a first surface 106, where the spiral channel 104 defines an inlet through hole 108 and an outlet through hole 110 and is configured to accept a first elongated member 116 along a length of the spiral channel 104. The reactor 100 includes a cover plate 114 on the output plate 112. Some implementations of the reactor 100 do not include the cover plate 114. The first elongated member is configured to provide UV radiation from a first UV radiation source along the length of the spiral channel 104. A wire exit hole 120 is configured to accept wires 118 of the first elongated member 116. The wires 118 of the first elongated member 116 are electrically connected to a power supply.

The input plate 102 is structured similarly to the output plate 112. Although not shown, the input plate 102 defines a spiral channel on a first surface of the input plate 102. The spiral channel defines an inlet through hole and an outlet through hole and is configured to accept a second elongated member along a length of the spiral channel. The second elongated member is configured to provide UV radiation from a second UV radiation source along the length of the spiral channel. Suitable materials for the input plate 102 and the output plate 112 include polymer (e.g., plastic), clay, or any combination thereof.

The input plate 102 is configured to couple with the output plate 112 such that fluid provided to the inlet through hole of the input plate flows through the spiral channel of the input plate 102, exits via the outlet through hole of the input plate 102, enters the inlet through hole 108 of the output plate 112, flows through the spiral channel 104 of the output plate 112, and exits the reactor 100 through the outlet through hole 110 of the output plate 112.

In some cases, the first and second elongated members are flexible. The flexibility allows the elongated members to be fitted into reactors of various shapes and configurations. Each elongated member can include a UV-LED strip, a side-emitting optical fiber, or any combination thereof. In some implementations, a diameter of the side-emitting optical fiber is in a range of 200 μm to 500 μm (e.g., in a range of 250 μm to 400 μm). The side-emitting optical fiber can include an optical fiber core with a coating including a fluoropolymer or a silica-based primer with a substituted optical-grade silicone. A thickness of the coating is in a range of 10 μm to 20 μm. In some cases, each elongated member includes a water-resistant coating. The water-resistant coating can include a fluoropolymer or other hydrophobic material. In some cases, the spiral channel 104 of the output plate 112 includes a plurality of first elongated members. In some cases, the spiral channel of the input plate 102 includes a plurality of second elongated members.

In some cases, the reactor 100 further includes a power source operatively coupled to the first elongated member and the second elongated member and configured to provide power to the first UV radiation source and the second UV radiation source. Suitable examples of the power source include a battery, a photovoltaic panel, or any combination thereof.

The reactor 100 can further include a gasket configured to form a seal between the input plate 102 and the output plate 112. The reactor 100 can further include a pump configured to provide the fluid to the inlet through hole 108 of the input plate 102.

Although not shown, the reactor 100 can further include one or more additional reactor plates, each defining a spiral channel on a first surface. Each spiral channel defines an inlet through hole and an outlet through hole and is configured to accept an additional elongated member along a length of the spiral channel. The additional elongated member is configured to provide UV radiation from an additional UV radiation source along the length of the additional spiral channel. In some cases, the one or more additional plates can be positioned between the input plate 102 and the output plate 112. In such cases, the fluid provided to the inlet through hole of the input plate 102 flows through the one or more additional plates and exits the reactor 100 through the outlet through hole 110 of the output plate 112. In some cases, each additional reactor plate of the one or more additional reactors plates includes a plurality of additional elongated members in each spiral channel.

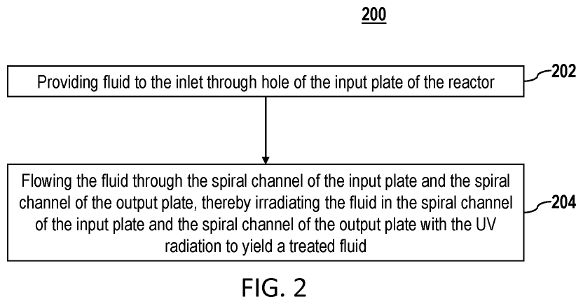

FIG. 2 is a flow chart showing operations in an example process 200 of treating a fluid in a stackable reactor (e.g., stackable reactor 100). In 202, the fluid is provided to the inlet through hole of an input plate of a reactor (e.g., the reactor of FIGS. 1A and 1B). The spiral channel of the input plate is configured to accept a first elongated member and the spiral channel of the output plate is configured to accept a second elongated member. The first elongated member is configured to provide UV radiation from a first UV radiation source along the length of the spiral channel of the input plate. The second elongated member is configured to provide UV radiation from a second UV radiation source along the length of the spiral channel of the output plate. Each elongated member can include a UV-LED strip, a side-emitting optical fiber, or any combination thereof. In some cases, the fluid is in direct contact with the first and second elongated members. In 204, the fluid flows through the spiral channel of the input plate and the spiral channel of the output plate. The fluid flowing through the spiral channel of the input plate and the spiral channel of the output plate is irradiated with the UV radiation of the first and second elongated members to yield a treated fluid.

In some implementations, the stackable reactor is configured for downward fluid flow, where the fluid travels from an upper plate toward a lower plate without a pump. In certain implementations, (e.g., in the process 200) the stackable reactor is configured for upward fluid flow (e.g., against the force of gravity). The process 200 can include pumping the fluid through the inlet through hole of the input plate. This allows the fluid to flow from a lower plate to an upper plate of the stackable reactor. The stackable reactors can operate in a passive mode (e.g., with the force of gravity) or in an active mode (e.g., with pumps configured to pump the fluid with or against the force of gravity), depending on the desired installation and operational parameters.

The fluid treated in the stackable reactor can be an aqueous fluid. In some cases, a contaminant level in the fluid exceeds a contaminant level in the treated fluid. A “treated fluid,” as used herein, generally refers to a fluid that has been exposed to UV radiation for a sufficient length of time to reduce a level of one or more contaminants in the fluid initially provided to the stackable reactor. The contaminants can include pathogenic bacteria, viruses, protozoa, and other microorganisms.

### EXAMPLES

In one example reactor, each stackable plate is spirally designed for water disinfection. These plates can be made from plastic sheets (e.g.,½ inch or ¾ inch thick), locally available clay, ceramics, mud materials, or 3D printed using polymer-based (e.g., filament or liquid polymer) or clay-based materials. Multiple plates can be stacked depending on the volume of water to be treated and contact time estimated for water disinfection. The reactor configuration uses at least two plates. These plates have a plug-flow configuration (e.g., spiral wall) with an inlet and outlet. Each plate is designed so that the outlet of each plate aligns with the inlet of the plate above or below, forming a flow path when the plates are stacked. In some cases, the reactor is installed as a freestanding unit (e.g., without additional structural support). The freestanding unit can be installed to disinfect water from a tank or a pipe. In certain cases, the reactor is submerged in a water tank to disinfect water.

### Example 1. Ultraviolet-C (UVC)-Light Emitting Diode (LED) Strips

Multiple UVC-LED chips/lights on a flexible strip were positioned at specific distances from each other on the strip's surface. If a UVC-LED chip fails, the remaining UVC-LED chips on the strip operate with negligible impact on disinfection performance. The flexible strip was fitted into a compact spiral wall in a multi-stack housing system with multiple plates.

The reactor system can be powered by 12V batteries or a small solar-powered photovoltaic (PV) panel for off-grid operation. For use inside the multi-stack reactor, the UVC-LED strips can be waterproofed by coating the LED light chip with a fluoropolymer or liquid glass (polymer), with negligible distortion of the UVC transmission or the irradiation of the UVC light. In this system, contaminated water comes in direct contact with the UVC-LED strips within the narrow channels to provide disinfection.

The stackable plates were designed with two ports (e.g., center and outer hole/ports as entry or exit ports, as shown in FIG. 1B). As the water entered from the center port of the bottom plate (e.g., input plate 102), the water travelled upward towards the center of the input plate 102 and then outwards in a spiral and in a plug-flow motion toward the outer edge exit hole. This outer exit port matches the inlet port of the upper stacked plate (e.g., inlet through hole 108 of output plate 112). Water entered the outer port of this plate and travelled spirally towards its inner outlet (e.g., outlet through hole 110). This process repeated itself from plate to plate in plug-flow motion, and water travelled from one plate to the next plate. The plates were fitted with flexible UVC-LED strips and held together by sealed gaskets. The water came in contact with the illuminated UVC-LED strip, traveling spirally in plug-flow motion from one plate to another during disinfection.

A three-plate reactor was evaluated for approximately 3-4 hours. During the assessment, contaminated water was introduced into the reactor through a center port of the bottom plate using a pump, and the treated water exited through the uppermost plate. To prepare the contaminated water, water was spiked with E. coli at a concentration greater than 10⁵ CFU/mL. A reduction of 0.5-1.5 logs (>75%-98%) in E. coli was observed within 45-60 minutes, with negligible deterioration of the UVC-LED strips. To increase the overall UVC dosage, the channels can be fitted with multiple or higher intensity or wattage UVC-LED strips. In some configurations, the reactor operates without a pump. For example, water can enter through the uppermost plate and flow downward under gravity.

### Example 2. Side-Emitting Optical Fibers

Side-emitting optical fibers were used as elongated members of the reactor. The side-emitting optical fibers used fiber bundles illuminated by a single LED light for water disinfection. Nineteen sets of 250-μm optical fibers (Polymicro/Molex, Arizona, USA) and nine sets of 400-μm Cytop-coated optical fibers were coated with embedded nanoparticles, forming a coating approximately 17.5 μm thick. Both types of fibers were mounted onto SMA 905 connectors.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A reactor comprising:
an input plate defining a spiral channel on a first surface, wherein the spiral channel defines an inlet through hole and an outlet through hole and is configured to accept a first elongated member along a length of the spiral channel, and the first elongated member is configured to provide UV radiation from a first UV radiation source along the length of the spiral channel; and
an output plate defining a spiral channel on a first surface, wherein the spiral channel defines an inlet through hole and an outlet through hole and is configured to accept a second elongated member along a length of the spiral channel, and the second elongated member is configured to provide UV radiation from a second UV radiation source along the length of the spiral channel,
wherein the input plate is configured to couple to the output plate such that fluid provided to the inlet through hole of the input plate flows through the spiral channel of the input plate, the outlet through hole of the input plate, the inlet through hole of the output plate, and the spiral channel of the output plate, and exits the reactor through the outlet through hole of the output plate.

2. The reactor of claim 1, wherein the input plate comprises plastic, clay, polymer, or any combination thereof.

3. The reactor of claim 1, wherein the output plate comprises plastic, clay, polymer, or any combination thereof.

4. The reactor of claim 1, wherein the first and second elongated members are flexible.

5. The reactor of claim 1, wherein each elongated member comprises a UV-LED strip, a side-emitting optical fiber, or any combination thereof.

6. The reactor of claim 5, wherein a diameter of the side-emitting optical fiber is in a range of 200 μm to 500 μm.

7. The reactor of claim 5, wherein the side-emitting optical fiber comprises a fluoropolymer coating.

8. The reactor of claim 7, wherein a thickness of the fluoropolymer coating is in a range of 10 μm to 20 μm.

9. The reactor of claim 1, wherein each elongated member comprises a water-resistant coating.

10. The reactor of claim 9, wherein the water-resistant coating comprises a fluoropolymer.

11. The reactor of claim 1, wherein the reactor further comprises a power source operatively coupled to the first elongated member and the second elongated member, and configured to provide power to the first UV radiation source and the second UV radiation source.

12. The reactor of claim 11, wherein the power source comprises a battery, a photovoltaic panel, or any combination thereof.

13. The reactor of claim 1, wherein the reactor further comprises a gasket configured to form a seal between the input plate and the output plate.

14. The reactor of claim 1, wherein the reactor further comprises a pump configured to provide the fluid to the inlet through hole of the input plate.

15. The reactor of claim 1, further comprising one or more additional plates, each defining a spiral channel on a first surface, wherein each spiral channel defines an inlet through hole and an outlet through hole and is configured to accept an additional elongated member along a length of the spiral channel, and the additional elongated member is configured to provide UV radiation from an additional UV radiation source along the length of the additional spiral channel, wherein the one or more additional plates are positioned between the input plate and the output plate, wherein fluid provided to the inlet through hole of the input plate flows through the one or more additional plates and the output plate and exits the reactor through the outlet through hole of the output plate.

16. A method of treating a fluid, the method comprising:
providing the fluid to the inlet through hole of the input plate of the reactor of claim 1; and
flowing the fluid through the spiral channel of the input plate and the spiral channel of the output plate, thereby irradiating the fluid in the spiral channel of the input plate and the spiral channel of the output plate with the UV radiation to yield a treated fluid.

17. The method of claim 16, wherein the fluid is in direct contact with the first and second elongated members.

18. The method of claim 16, further comprising pumping the fluid through the inlet through hole of the input plate.

19. The method of claim 16, wherein the fluid comprises water.

20. The method of claim 16, wherein a contaminant level in the fluid exceeds a contaminant level in the treated fluid.
